(19) United States
(12) Patent Application Publication
(10) Pub. No.: US 2013/0149537 A1
(43) Pub. Date: Jun. 13, 2013

(54) HARD COATING COMPOSITION

(71) Applicants: SAMSUNG ELECTRONICS CO., LTD., Suwon-si (KR); INDUSTRY-UNIVERSITY CORPORATION FOUNDATION HANYANG UNIVERSITY (IUCF-HYU), Seoul (KR)

(72) Inventors: Yeon Kyoung JUNG, Seoul (KR); Kyung Kook Kim, Yongin-si (KR); Kyong Il Kim, Seoul (KR); Joo Ho Kim, Suwon-si (KR); Sang Man Koo, Seoul (KR); Jung Soo Kim, Seoul (KR); Eun Gu Jung, Nonsan-si (KR)

(73) Assignees: INDUSTRY-UNIVERSITY CORPORATION FOUNDATION HANYANG UNIVERSITY (IUCF-HYU), Seoul (KR); SAMSUNG ELECTRONICS CO., LTD., Suwon-si (KR)

(21) Appl. No.: 13/712,261

(22) Filed: Dec. 12, 2012

(30) Foreign Application Priority Data
Dec. 13, 2011 (KR) 10-2011-0133373

(51) Int. Cl. C09D 133/08

(52) U.S. Cl. CPC C09D 133/08
USPC 428/407; 522/33

(57) ABSTRACT

A hard coating composition capable of being applied to the modification of a surface of plastic material that is being widely used in household appliances, the hard coating composition including an inorganic dispersion solution that is composed of at least one hydrolytically decomposable silane compound and an inorganic oxide particle, and an organic resin solution that is composed of a photo-curable acrylic-based compound and various additives capable of providing a functionality, such as a surface improving agent and an anti-static agent, the hard coating composition providing pH of between 4 and 6.

### CROSS-REFERENCE TO RELATED APPLICATIONS

This application claims the benefit of Korean Patent Application No. 10-2011-0133373, filed on Dec. 13, 2011, in the Korean Intellectual Property Office, the disclosure of which is incorporated herein by reference.

### BACKGROUND

1. Field

Embodiments of the present disclosure relate to a hard coating composition, and more particularly, to a hybrid coating composition configured to be applicable on a surface of plastic material of household appliances.

2. Description of the Related Art

The plastic material, such as, PMMA (polymethylmethacrylate), PET (polyethyleneterehthalate), and PC (polycarbonate) are being used because they are lightweight, provided with superior durability, and easily molded by heat. However, the plastic material is provided with low surface hardness, and due to the limit in the physical/chemical characteristic thereof poor abrasion resistance and solvent resistance, a wider use of the plastic material is limited.

As to resolve the difficulties as such, various types of functional hard coating material are being developed. Particularly, the development of the coating material using organic/inorganic hybrid material being produced through a sol-gel processing is being a mainstream.

A hard coating material may be divided into an organic coating material using melamine, acryl, and urethane, inorganic coating material using silicon-based material, and organic/inorganic hybrid coating material that uses by combining inorganic-based material and organic-based material.

A coating composition that is composed of the inorganic material such as silicon material, when compared to the organic-based coating material, is provided with superior surface hardness and abrasion resistance. However, such a coating is provided with brittleness, and at the same time, a thick film coating may be difficult due to the generation of a crack such as an evaporation of a solvent in a drying process and a hardening process.

As to overcome the difficulty as such, a development of hybrid coating material that uses organic/inorganic material is being taken place.

However, the organic/inorganic hybrid coating material and the coating composition that may be used in coating of transparent plastic material are less sufficient in forming a coating layer having a satisfactory material characteristic, and since the hardness of the coating layer is low and the adhesion between the coating layer and the plastic substrate is low, making such as a product may be difficult.

### SUMMARY

Therefore, it is an aspect of the present disclosure to provide a hard coating composition including an inorganic dispersion solution that is composed of at least one hydrolytically decomposable silane compound and an inorganic oxide particle, and an organic resin solution that is composed of a photo-curable acrylic-based compound and various additives capable of providing a functionality, such as a surface improving agent and an anti-static agent, the hard coating composition providing pH of between 4 and 6.

Additional aspects will be set forth in part in the description which follows and, in part, will be obvious from the description, or may be learned by practice of the disclosure.

In accordance with one aspect, a hard coating composition includes a surface-modified Boehmite nano particle of 5 to 50 weight %, a photo-hardening-type acrylate compound of 10 to 50 weight %, an organic solvent of 30 to 70 of weight %, and a photo-initiator of 1 to 10 weight %, wherein the hard coating composition is provided with a pH thereof between 4 to 6.

A surface of the Boehmite nano particle may be modified with an alkoxy silane compound, and the alkoxy silane compound includes at least one of an acrylic-based alkoxy silane compound and a vinyl-based alkoxy silane compound.

The photo-hardening-type acrylate compound may include at least one of acrylate monomer, urethane acrylate, polyester acrylate, polyether acrylate, and acrylic acrylate.

The organic solvent may include at least one of methanol, ethanol, isopropanol, normal-propanol, butanol, isobutanol, ethyl-cellosolve, methyl-cellosolve, butyl-celloslove, butyl-acetate, diacetone alcohol, methyl-ethyl ketone, propylene glycol, isopropyl alcohol, and ethylene-glycol isopropyl alcohol.

The photo-initiator may include at least one type of a benzo-phenone type, an acetone-phenone type, a benzoin-ether type, benzyl-ketal type, a thioctic-xanthone type, and an anthraquinone type.

The hard coating composition may further include a surface improving material or an anti-static material, or the like.

The pH may be controlled through at least one of monoethanolamine, diethanolamine, and triethanolamine.

The Boehmite nano particle may be acicular.

The Boehmite nano particle may have a size from 1 nm to 20 nm.

The surface modification of the Boehmite nano particle may be performed at a temperature between 60° C. and 80° C.

In a case when the surface of the Boehmite nano particle is being modified, the pH of the solvent having the dispersed Boehmite nano particle may be controlled at between 3 and 5.

In accordance with another aspect, a product having a surface coated with a hard coating composition is characterized by having the hard coating composition that includes a surface-modified Boehmite nano particle of 5 to 50 weight %, a photo hardening-type acrylate compound of 10 to 50 weight %, an organic solvent of 30 to 70 weight %, and a photo-initiator of 1 to 10 weight %.

A pH of the hard coating composition may be between 4 and 6.

A surface of the Boehmite nano particle may be modified with an alkoxy silane compound, and the alkoxy silane compound may include at least one of an acrylic-based alkoxy silane compound and a vinyl-based alkoxy silane compound.

The photo hardening-type acrylate compound may include at least one of acrylate monomer, urethane acrylate, polyester acrylate, polyether acrylate, and acrylic acrylate.

The organic solvent may include at least one of methanol, ethanol, isopropanol, normal-propanol, butanol, isobutanol, ethyl-cellosolve, methyl-cellosolve, butyl-celloslove, butyl-acetate, diacetone alcohol, methyl-ethyl ketone, propylene glycol, isopropyl alcohol, and ethylene-glycol isopropyl alcohol.

The photo-initiator may include at least one type of a benzo-phenone type, an acetone-phenone type, a benzoin-ether type, benzyl-ketal type, a thioctic-xanthone type, and an anthraquinone type.

The product may further include a surface improving material or an anti-static material.

The pH may be controlled through at least one of monoethanolamine, diethanolamine, triethanolamine and triethylamine.

The Boehmite nano particle may be acicular.

The Boehmite nano particle may have a size from 1 nm to 20 nm.

The surface modification of the Boehmite nano particle may be performed at a temperature between 60° C. and 80° C.

In a case when the surface of the Boehmite nano particle is being modified, the pH of the solvent having the dispersed Boehmite nano particle may be controlled at between 3 and 5.

In accordance with one aspect, a hard coating composition is capable of enhancing the surface hardness and the abrasion resistance, both of which are regarded as drawbacks of plastic panel, without reducing the transparency of the plastic material for household appliances such as a washing machine, an air conditioner, and a refrigerator.

In addition, since the adhesiveness with a plastic panel is superior, the hard coating composition may be used in various areas.

### DETAILED DESCRIPTION

Inorganic nano particles of a hard coating composition in accordance with one embodiment may be obtained by performing a peptization after a hydrolysis of a metallic alkoxide, such as methoxide, ethoxide, isopropoxide, and butoxide, is performed in water.

In more detail, first, after obtaining a sediment in the form of a metallic hydrate having a cohesive form by performing a hydrolysis on a metallic alkoxide in an excess amount of water, and a strong acid such as a nitric acid or a hydrochloric acid is added to the sediment to perform a reaction for a number of hours at a temperature between 70° C. and 100° C., preferably between 80° C. and 90° C., so that a stable inorganic nano-sol having a size in nano units may be produced.

Most of the commercialized coating composition liquid having inorganic particle is used together with an organic binder, or is used in a manner to be dispersed in an organic solvent using a silane coupling agent.

In a case when a large amount of the organic binder is used, the content of the organic material is increased, and thus the surface hardness is reduced, and in a case when a reduced amount of the organic matter is used, since a dispersion may be difficult, the hard coating composition may not be used as a coating liquid, and thereby the production of hard coating material provided with superior surface hardness only by having a silica and a silane coupling agent is limited.

Thus, the hard coating composition in accordance with one embodiment, as to produce a hard coating composition having higher hardness, is configured to use Boehmite, which is an inorganic nano particle, having higher surface hardness than the hardness of silica.

A silane compound that is used on the modification of the surface of the inorganic nano particle is an alkoxy silane compound, and particularly, may be selected from an acrylic-based alkoxide silane compound or a vinyl-based alkoxy silane compound.

The Boehmite nano particle may be an aciform.

The Boehmite nano particle is pre-processed by the acrylic-based alkoxide silane or the vinyl-based alkoxy silane, which are the organic silane coupling agents having an acrylic group and a vinyl group through a sol-gel method, so that hard coating liquid having an organic/inorganic nano particle hard coating composition liquid having superior dispersibility in organic solvent.

The coating composition as such, by the characteristic of the Boehmite having superior surface hardness, may be provided with an enhanced abrasion resistance when compared to silica, and may be provided with superior dispersibility with respect to the organic solution by a silane coupling agent.

The hybrid nano particle produced as such is provided with a structure of an Al—O—Si, and may form a coating film having high abrasion resistance after a hardening is performed.

In the present disclosure, the reaction to perform a modification of the surface of the Boehmite with a silane compound is proceeded in the range of pH 3 and pH 5.

The electrical charge of the surface of the Boehmite particle, which is charged with a strong positive (+) charge in an acid state, is approached to about 0 at the range of pH 6 to pH 7, in other words, the repulsive force on the surface of the Boehmite particle is reduced due to the loss of the electrical charge of the surface of the Boehmite particle, and thereby causing the cohesion of the sol.

That is, with respect to the Boehmite particle, since the partial positive charge of aluminum is shown at a relatively larger scale, in a case when a loss of the electrical charge of the surface is occurred, a nano-size particle has a tendency of showing a strong cohesion for stabilization as to recover the loss as such.

In addition, in a case when the surface of a particle is modified with an organic silane, a sol-gel method is being used, and the sol-gel method requires a reaction under an acid state serving as catalysis reaction to promote a hydrolysis reaction and a condensation reaction.

A photo-hardening-type acrylate compound of a hard coating composition in accordance with one embodiment may be selected from an acrylate monomer, a urethane acrylate, a polyester acrylate, a polyether acrylate, and an acrylic acrylate.

The acrylic compound, by performing a role as a cross-linking agent with respect to the modified particles, may be able to produce a further solid coating film, and in order to obtain the optimal coating layer, 10 to 65 weight parts of a modification particle and 35 to 90 weight parts of an acrylic-based monomer are required on a basis of 100 parts by weight of solid content of the coating liquid.

As for an initiator of a hard coating composition in accordance with one embodiment of the present disclosure, a conventional polymerization initiator, which is configured to enable a hardening while forming a radical when an UV is radiated, is used, and the initiator may includes a benzo-phenone type initiator, an acetone-phenone type initiator, a benzoin-ether type initiator, a benzyl-ketal type initiator, a thioctic-xanthone type initiator, and an anthraquinone type initiator, and from the above initiators, the benzophenone, 1-hydroxy cyclohexyl phenyl ketone, and α-amino acetophenone may be used.

An UV initiator, by forming a radical as a weak coupling is broken by an UV during a chemical combination of the initiator, enables a fast and solid hardening to take place. The content of the initiator to obtain an optimal coating film, on a basis of 100 parts of solid content of the coating liquid, may be 3 to 10 weight parts, or preferably, 5 to 7 weight parts.

In addition, alcohol is used as a solvent to disperse the coating liquid. The acrylic-based alkoxy silane or the organic silane, which are added in the present disclosure may be able to maintain the stability of the inorganic nano particle in accordance with the addition of the alcohol-like solvent. Thus, even when the composition of the solvent is changed, the stability of the particle is maintained. As for the ratio of the added alcohol, which is a solvent, the ratio of the solid content of a coating liquid and the alcohol is provided to be from 3:2 to 2:3 in terms of a weight ratio.

The coating liquid as such, in a case when being coated on the substrates of various materials, may be able to form a strong, colorless, and transparent coating film by silanol generated by the hydrolysis of the acrylic-based alkoxide silane compound, or by the functional group of an acryl group of the acrylic based compound.

In addition, by considering the miscibility with water and the drying speed after a coating, the alcohol may be used by selecting more than one type of alcohol from methane, ethanol, 1-propanol, and 2-propanol.

By adding a TEA (triethanolamine) to the coating liquid that is ultimately produced in the present disclosure, the coating liquid may be produced having various pHs.

As the pH is increased, the electrical charges of the surface of the Boehmite having an IEP (isoelectric point) at between 7 and 8 are reduced, and accordingly, the viscosity is enhanced. Through such, the thickness of the coating film may be controlled not only through an increase of the solid content but also through the controlling of the pH of the coating liquid without having to increase a solid content, the controlling of the Ph of the coating liquid also enabling the enhancement of the hardness.

As to secure the transparency and the convenience of a processing while enhancing a surface hardness, the pH of the coating liquid is preferred to be adjusted in the range between 4 and 6.

The substrates at which the hard coating composition in accordance with one embodiment of the present disclosure may be used in a useful manner include the substrates that are formed of glass, stainless steel, ceramics, aluminum, and plastic, and by applying a coating on the substrates as such using a spin coating method, a deep coating method, a flow coating method, and a spray coating method, a coating film having high hardness and transparency may be formed.

Hereinafter, the descriptions will be provided more in detail through the following embodiments and comparative examples.

### Embodiments

### Production of Boehmite Nano particle and Modification of Surface of Boehmite Nano Particle

Water of about 5 L and aluminum isopropoxide of 2.45 mol are placed in a reactor and then stirred to obtain sediment that is hydrolyzed. Then, a nitrate of about 0.288 mol is added, and by gradually increasing the temperature, a peptization reaction is induced. While maintaining the pH in the range of 3.6 and 4.0, a reaction is performed for about 6 hours at a temperature of 90 degrees, and the Boehmite sol, which is opaque, is obtained. By stirring the Boehmite nano sol obtained as such, the Boehmite sol is evaporated under a decompression to obtain Boehmite nano particles. As a result of the TEM analysis, the size of the Boehmite nano particle is provided with the size of several nanometers, while the compounded Boehmite is in match with the planes of the crystal lattice of each of (020), (120), (031), and (200) of a Boehmite phase of JCPDS (No. 31-1307) and is present in the form of a γ-AlOOH. Then, with respect to Boehmite nano particle obtained, distilled water of about 100 mL and the Boehmite particle of about 83.33 mmol are placed in a reactor, which is provided with a mechanical stirrer installed thereto, to produce the evenly dispersed Boehmite nano sol. Next, by adding the 3-(trimethoxysilyl) propyl methacrylate of about 47.34 mmol and the triethoxyvinylsilane of about 12.34 mmol to the dispersed liquid, and the temperature is increased to about 70° C. to induce the hydrolysis and the condensation reaction between the Boehmite and the organic silane for about 30 minutes, and thus sediment that is agglomerated at an inside the reactor is obtained. The sediment as such is formed by the lipophilic characteristic of the acrylate in water, and after the completion of the reaction, the Boehmite particle, which is surface-modified with an organic silane, is ultimately obtained by a filter apparatus.

### Embodiments 1 to 4

A 60% solution is produced by dispersing the Boehmite particle, which is grafted with an organic group produced as above, and an acrylate compound (SC2153) in isopropyl alcohol at a weight ratio of about 45:55. Then, by adding 7 weight parts of 1-hydroxy cyclohexyl phenyl ketone (IRG-184) as an UV initiator with respect to the solid content, a coating liquid is produced. After then, by adding a triethanolamine at about 0.5 to 3 weight parts, final coating liquids having pHs of 4, 4.5, 5, and 5.5 are produced

### Comparative Example 1

Except that a 40% solution, which is provided with the surface-modified Boehmite particle and the acrylate compound dispersed isopropyl alcohol at the weight ratio of about 50:50, is being used, the comparison is performed using the same methods the above embodiments 1 to 4.

### Comparative Example 2

Except that a 50% solution, which is provided with the surface-modified Boehmite particle and the acrylate compound dispersed in isopropyl alcohol at the weight ratio of about 50:50, is being used, the comparison is performed using the same methods the above embodiments 1 to 4.

The components of the coating composition produced at the embodiments and the comparative examples are shown on the [Table 1] below:

TABLE 1

| | Modified | Acrylic- | | | |
|---|---|---|---|---|---|
| | Inorganic | based | | Organic | |
| Category | Particle | Compound | Initiator | Solvent | pH |
| Embodiment 1 | 0.9 g | 1.1 g | 0.14 g | 1.3 g | 4 |
| Embodiment 2 | 0.9 g | 1.1 g | 0.14 g | 1.3 g | 4.5 |
| Embodiment 3 | 0.9 g | 1.1 g | 0.14 g | 1.3 g | 5 |
| Embodiment 4 | 0.9 g | 1.1 g | 0.14 g | 1.3 g | 5.5 |
| Comparative | 1.0 g | 1.0 g | 0.14 g | 3.0 g | 3.5 |
| Example 1 | | | | | |
| Comparative | 1.0 g | 1.0 g | 0.14 g | 2.0 g | 3.5 |
| Example 2 | | | | | |

With respect to the coating composition, a PMMA panel, which is provided with the width and the length thereof at about 5 cm each, is thoroughly cleaned with IsopropylAlcohol for the coating composition to be applied thereon, and through a spin coating method, a coating film is produced, and an UV hardening is performed after a natural drying process of about 10 minutes. After the completion of the above, the physical properties of the coating film is evaluated as follows:

### Transmittance/Haze

By using a Hazemeter (NDH-5000), the total transmittance and a haze of a coating sample are measured.

### Transmittance (T) ∘: T≧90%, Δ: 75%≦T<90%, X: T<75%

### Haze (H) ∘: H≦2%, Δ: 2%<H≦5%, X: 5%<H

### Pencil Hardness

The pencil hardness is measured by inserting a pencil, which is prepared for a hardness measurement, into a pencil hardness tester (QM450A) at a 45-degree angle, and by applying a certain weight (0.5 kg) on the coating film that is formed on the PMMA substrate. As for the pencils, Mitsubishi pencils having the strengths of H-9H, F, HB, and B-6B are used. The hardness of the lead of each pencil occurring no scratch after three attempts is measured.

### Adhesiveness

With respect to the adhesiveness test, a cross-cut test is used. By using a cross cutter, the coating film having the width and length of about 10 mm is divided into 10×10 sections while each of the 100 sections is provided with the width about 1 mm, and the length of about 1 mm. Then, on the total of 100 sections, a strip of 3M scotch tape is placed and closely adhered by use of a hand. Next, the strip of 3M scotch tape is removed instantly from the 100 sections in a perpendicular direction to the direction of the strip of 3M scotch tape is placed on the 100 sections. At this time, by measuring the number of the rectangular sections that remain on the coating layer, the adhesiveness is evaluated.

Adhesiveness=Number of Remaining Rectangular Sections/100

### Abrasion Resistance

With respect to the evaluation of the abrasion resistance, a printing abrasion tester is used. After fixing the coating layer sample to a tester, a friction ruler having a diameter of about 28 mm is wrapped with a cotton cloth, and while applying a weight of about 2 kg on the friction ruler, the abrasion is performed for about 2,000 times at the frequency of about 45 round trips in a minute. After the above process, the surface is investigated.

∘: No trace of peeling or abrasion, Δ: Minor abrasion occurred, X: Peeling of coated surface occurred

The physical properties of the coating film that is produced according to the embodiments 1 to 4 as well as the comparative examples 1 and 2 are as follows:

TABLE 2

| | Trans- | | Pencil | Adhesive- | Abrasion |
|---|---|---|---|---|---|
| Category | mittance | Haze | Hardness | ness | Resistance |
| Embodiment 1 | ∘ | ∘ | 7H | 100/100 | ∘ |
| Embodiment 2 | ∘ | ∘ | 8H | 100/100 | ∘ |
| Embodiment 3 | ∘ | ∘ | 9H | 100/100 | ∘ |
| Embodiment 4 | ∘ | ∘ | 9H | 100/100 | ∘ |
| Comparative | ∘ | ∘ | 5H | 100/100 | ∘ |
| Example 1 | ∘ | ∘ | | | ∘ |
| Comparative | ∘ | ∘ | 6H | 100/100 | ∘ |
| Example 2 | ∘ | ∘ | | | |

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A hard coating composition, comprising:
a surface-modified Boehmite nano particle of 5 to 50 weight %;
a photo-hardening-type acrylate compound of 10 to 50 weight %;
an organic solvent of 30 to 70 of weight %; and
a photo-initiator of 1 to 10 weight %,
wherein the hard coating composition is provided with a pH thereof between 4 to 6.

2. The hard coating composition of claim 1, wherein:
a surface of the Boehmite nano particle is modified with an alkoxy silane compound, and
the alkoxy silane compound comprises at least one of an acrylic-based alkoxy silane compound and a vinyl-based alkoxy silane compound.

3. The hard coating composition of claim 1, wherein:
the photo-hardening-type acrylate compound comprises at least one of acrylate monomer, urethane acrylate, polyester acrylate, polyether acrylate, and acrylic acrylate.

4. The hard coating composition of claim 1, wherein:
the organic solvent comprises at least one of methanol, ethanol, isopropanol, normal-propanol, butanol, isobutanol, ethyl-cellosolve, methyl-cellosolve, butyl-celloslove, butyl-acetate, diacetone alcohol, methyl-ethyl ketone, propylene glycol, isopropyl alcohol, and ethylene-glycol isopropyl alcohol.

5. The hard coating composition of claim 1, wherein:
the photo-initiator comprises at least one type of a benzo-phenone type, an acetone-phenone type, a benzoin-ether type, benzyl-ketal type, a thioctic-xanthone type, and an anthraquinone type.

6. The hard coating composition of claim 1, further comprising:
a surface improving material or an anti-static material.

7. The hard coating composition of claim 1, wherein:
the pH is controlled through at least one of monoethanolamine, diethanolamine, and triethanolamine.

8. The hard coating composition of claim 1, wherein:
the Boehmite nano particle is acicular.

9. The hard coating composition of claim 1, wherein:
the Boehmite nano particle has a size from 1 nm to 20 nm.

10. The hard coating composition of claim 1, wherein:
the surface modification of the Boehmite nano particle is performed at a temperature between 60° C. and 80° C.

11. The hard coating composition of claim 1, wherein:
in a case when the surface of the Boehmite nano particle is being modified, the pH of the solvent having the dispersed Boehmite nano particle is controlled at between 3 and 5.

12. A product having a surface coated with a hard coating composition, the hard coating composition characterized by including:
a surface-modified Boehmite nano particle of 5 to 50 weight %;
a photo hardening-type acrylate compound of 10 to 50 weight %;
an organic solvent of 30 to 70 weight %; and
a photo-initiator of 1 to 10 weight %.

13. The product of claim 12, wherein:
a pH of the hard coating composition is between 4 and 6.

14. The product of claim 12, wherein:
a surface of the Boehmite nano particle is modified with an alkoxy silane compound, and the alkoxy silane compound comprises at least one of an acrylic-based alkoxy silane compound and a vinyl-based alkoxy silane compound.

15. The product of claim 12, wherein:
the photo hardening-type acrylate compound comprises at least one of acrylate monomer, urethane acrylate, polyester acrylate, polyether acrylate, and acrylic acrylate.

16. The product of claim 12, wherein:
the organic solvent comprises at least one of methanol, ethanol, isopropanol, normal-propanol, butanol, isobutanol, ethyl-cellosolve, methyl-cellosolve, butyl-celloslove, butyl-acetate, diacetone alcohol, methyl-ethyl ketone, propylene glycol, isopropyl alcohol, and ethylene-glycol isopropyl alcohol.

17. The product of claim 12, wherein:
the photo-initiator comprises at least one type of a benzo-phenone type, an acetone-phenone type, a benzoin-ether type, benzyl-ketal type, a thioctic-xanthone type, and an anthraquinone type.

18. The product of claim 12, further comprising:
a surface improving material or an anti-static material.

19. The product of claim 12, wherein:
the pH is controlled through at least one of monoethanolamine, diethanolamine, triethanolamine and triethylamine.

20. The product of claim 12, wherein:
the Boehmite nano particle is acicular.

21. The product of claim 12, wherein:
the Boehmite nano particle has a size from 1 nm to 20 nm.

22. The product of claim 12, wherein:
the surface modification of the Boehmite nano particle is performed at a temperature between 60° C. and 80° C.

23. The product of claim 12, wherein:
in a case when the surface of the Boehmite nano particle is being modified, the pH of the solvent having the dispersed Boehmite nano particle is controlled at between 3 and 5.
